(19) United States
(12) Patent Application Publication
(10) Pub. No.: US 2022/0101321 A1
(43) Pub. Date: Mar. 31, 2022

(54) SYSTEMS AND METHODS FOR PROCESSING RESOURCE TRANSFER REQUESTS

(71) Applicant: The Toronto-Dominion Bank, Toronto (CA)

(72) Inventors: Christopher Mark JONES, Villanova, PA (US); Barry Wayne BAIRD, JR., Kennett Square, PA (US); Claude Bernell LAWRENCE, JR., Philadelphia, PA (US); Jonathan Joseph PRENDERGAST, West Chester, PA (US)

(73) Assignee: The Toronto-Dominion Bank, Toronto (CA)

(21) Appl. No.: 17/034,674

(22) Filed: Sep. 28, 2020

(51) Int. Cl. G06Q 20/40

(52) U.S. Cl. CPC G06Q 20/405; G06Q 20/4037

(57) ABSTRACT

A processor-implemented method is disclosed. The method includes: obtaining definition of transfer configuration rules for automatically handling requests for transfer of resources, the transfer configuration rules defining a plurality of handling actions for processing resource transfer requests and criteria associated with the respective handling actions, wherein the transfer configuration rules are generated based on historical transaction preference data associated with an entity; receiving, from a computing system, a first resource transfer request; determining that the first resource transfer request satisfies criteria defined in the transfer configuration rules that are associated with a first one of the plurality of handling actions; and in response to determining that the first resource transfer request satisfies the criteria associated with the first handling action, processing the first resource transfer request in accordance with the first handling action. eodcmaster

### TECHNICAL FIELD

The present application relates to data processing and, more particularly, to systems and methods for processing resource transfer requests in a networked environment.

### BACKGROUND

Requests for resources (e.g. computing resources, data, etc.) from multiple different sources may be directed to a central computing system that processes and handles such requests. By way of example, a server computer that manages a plurality of resource accounts may handle requests from various computing systems to share, distribute, or otherwise transfer resources associated with the accounts to specific recipients. Manual processing of such resource requests may result in unintended errors or delays. For example, in the context of requests for real-time (or near real-time) transfer of resources, any delays which may be introduced by manual processing of resource requests can cause subsequent processes and actions by the intended recipients to be delayed or fail entirely.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method for processing a resource transfer request from a transfer request issuing server;

FIG. 4 shows, in flowchart form, an example method for determining a suitable handling action for processing a resource transfer request; and

FIG. 5 shows, in flowchart form, an example method for generating recommendations of transfer configuration rules for a resource transfer.

Like reference numerals are used in the drawings to denote like elements and features.

### DETAILED DESCRIPTION OF VARIOUS EMBODIMENTS

In an aspect, a computing device is disclosed. The computing device includes a processor, a communications module coupled to the processor, and a memory coupled to the processor. The memory stores instructions that, when executed, configure the processor to: obtain definition of transfer configuration rules for automatically handling requests for transfer of resources, the transfer configuration rules defining a plurality of handling actions for processing resource transfer requests and criteria associated with the respective handling actions, wherein the transfer configuration rules are generated based on historical transaction preference data associated with an entity; receive, from a computing system, a first resource transfer request; determine that the first resource transfer request satisfies criteria defined in the transfer configuration rules that are associated with a first one of the plurality of handling actions; and in response to determining that the first resource transfer request satisfies the criteria associated with the first handling action, process the first resource transfer request in accordance with the first handling action.

In some implementations, the criteria may include at least one of: a threshold representing a maximum amount for a handling action to apply; a transferee identifier indicating a transferee for which the handling action is to apply; or an account balance indicating a minimum account balance for the handling action to apply.

In some implementations, the transfer configuration rules may include definition of one or more time periods corresponding to the respective handling actions.

In some implementations, obtaining the definition of transfer configuration rules may include receiving, from a client device, input of the definition of transfer configuration rules.

In some implementations, the transfer configuration rules may include definition of one or more accounts from which transfer of resources may be initiated for handling resource transfer requests.

In some implementations, the transfer configuration rules may include at least a primary set of rules and a secondary set of rules, the secondary set of rules including definition of at least one handling action and corresponding criteria, wherein the handling action defined by the primary set of rules may be different from that defined by the secondary set of rules.

In some implementations, determining that the first resource transfer request satisfies criteria defined in the transfer configuration rules that are associated with a first one of the plurality of handling actions may include: determining that the first resource transfer request does not satisfy criteria associated with any of the handling actions defined in the primary set of rules; and in response to determining that the first resource transfer request does not satisfy criteria associated with any of the handling actions defined in the primary set of rules, checking criteria associated with the at least one handling action defined in the secondary set of rules.

In some implementations, the transfer configuration rules may include definition of quantum of resources for transfer associated with the respective handling actions.

In some implementations, the transfer configuration rules may include a set of default handling actions for processing resource transfer requests.

In some implementations, the instructions, when executed, may further configure the processor to: generate recommendations of one or more transfer configuration rules based on the historical transaction preference data; and provide, to a client device, the generated recommendations.

In another aspect, a processor-implemented method is disclosed. The method includes: obtaining definition of transfer configuration rules for automatically handling requests for transfer of resources, the transfer configuration rules defining a plurality of handling actions for processing resource transfer requests and criteria associated with the respective handling actions, wherein the transfer configuration rules are generated based on historical transaction preference data associated with an entity; receiving, from a computing system, a first resource transfer request; determining that the first resource transfer request satisfies criteria defined in the transfer configuration rules that are associated with a first one of the plurality of handling actions; and in response to determining that the first resource transfer request satisfies the criteria associated with the first handling action, processing the first resource transfer request in accordance with the first handling action.

In yet another aspect, a computer-readable storage medium is disclosed. The storage medium stores instructions that, when executed by a processor, cause the process to perform operations comprising: obtain definition of transfer configuration rules for automatically handling requests for transfer of resources, the transfer configuration rules defining a plurality of handling actions for processing resource transfer requests and criteria associated with the respective handling actions, wherein the transfer configuration rules are generated based on historical transaction preference data associated with an entity; receive, from a computing system, a first resource transfer request; determine that the first resource transfer request satisfies criteria defined in the transfer configuration rules that are associated with a first one of the plurality of handling actions; and in response to determining that the first resource transfer request satisfies the criteria associated with the first handling action, process the first resource transfer request in accordance with the first handling action.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

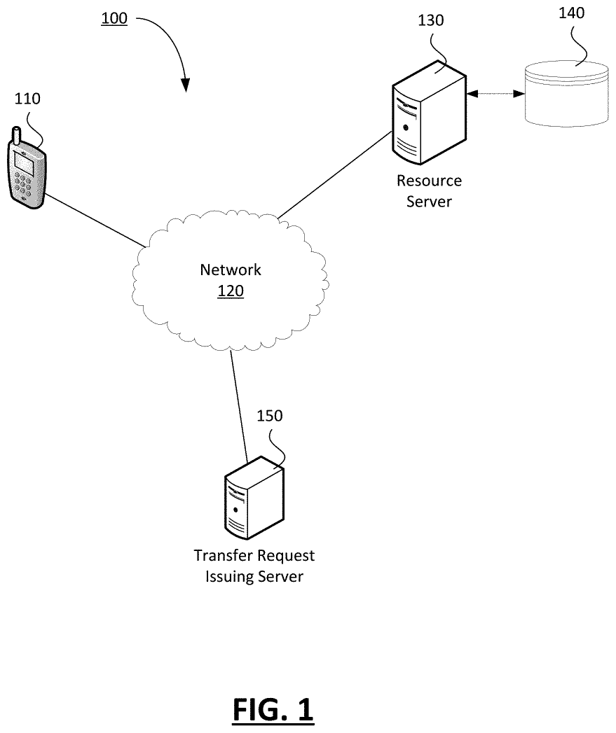

FIG. 1 is a schematic diagram illustrating an operating environment of an example embodiment. In particular, FIG. 1 illustrates exemplary components of a system 100 for processing resource transfer requests. As a specific example, the system 100 may be implemented to facilitate automated processing and handling of requests to transfer funds (e.g. bill payment transactions, etc.) to a specific recipient/transferee. More generally, the components of system 100 enable automated processing of resource transfer requests that are directed to a resource management system.

As illustrated, a resource server 130 (which may also be referred to as a server computer system) and client device 110 communicate via the network 120. The client device 110 is a computing device which may be associated with an entity, such as a user or client, having resources associated with the resource server 130. For example, the resource server 130 may track, manage, and maintain resources, make lending decisions, and/or lend resources to the entity. The resources may, for example, be computing resources, such as memory or processor cycles. By way of further example, the resources may include stored value, such as fiat currency, which may be represented in a database. For example, the resource server 130 may be coupled to a database 140, which may be provided in secure storage. The secure storage may be provided internally within the resource server 130 or externally. The secure storage may, for example, be provided remotely from the resource server 130. For example, the secure storage may include one or more data centers. The data centers may, for example, store data with bank-grade security.

The resource server 130 includes a resource request processing engine (not shown in FIG. 1). The resource request processing engine may be implemented to automatically process resource transfer requests that are received from various sources. More specifically, the resource request processing engine is configured to process requests to transfer resources that are associated with one or more resource accounts, in accordance with defined handling actions. In particular, the resource request processing engine is configured to automatically process resource transfer requests without manual intervention by related entities (e.g. resource server administrator, clients associated with resource accounts, etc.) for the resource transfer requests.

In some embodiments, the system 100 may include a resource lending adjudication server (not shown in FIG. 1) that is independent of the resource server 130. A resource lending adjudication server may implement a service which receives resource requests and automatically processes the resource requests to render resource lending approval data for requesting entities. This adjudication service may be implemented by a server that is different from the resource server 130. For example, a resource lending adjudication server that is communicably connected to the resource server 130 and has access to resource accounts data maintained by the resource server 130 may be configured to provide an adjudication service for resource requests.

The database 140 may include records for a plurality of accounts and at least some of the records may define a quantity of resources associated with an entity. For example, the entity that is associated with the client device 110 may be associated with an account having one or more records in the database. The records may reflect a quantity of stored resources that are associated with the entity. Such resources may include owned resources and, in at least some embodiments, borrowed resources (e.g. resources available on credit). The quantity of resources that are available to or associated with an entity may be reflected by a balance defined in an associated record such as, for example, a bank balance.

The database 140 may also store transfer configuration rules data comprising rules for handling resource transfer requests that are directed to the resource server 130. As will be described in greater detail below, various transfer configuration rules may be defined for specifying handling actions for automatically processing resource transfer requests to the resource server 130. Upon receiving a resource transfer request (e.g. from a transfer request issuing server), the resource server 130 may access the database 140 to identify transfer configuration rules that are relevant to the resource transfer request and determine a suitable handling action based on the identified rules. Additionally, or alternatively, the transfer configuration rules data may be stored externally of the database 140.

The resource server 130 may, for example, be a financial institution server and the entity may be a customer of a financial institution operating the financial institution server.

The client device 110 may be used, for example, to configure a resource transfer from an account associated with the client device 110. More particularly, the client device 110 may be used to configure a resource transfer from an account associated with an entity operating the client device 110. The resource transfer may involve a transfer of data between a record in the database 140 associated with such an account and another record in the database 140 (or in another database such as a database associated with another server (not shown) which may be provided by another financial institution, for example, and which may be coupled to the resource server 130 via a network). The other record is associated with a resource transfer recipient such as, for example, a bill payment recipient. The data involved in the transfer may, for example, be units of value and the records involved in the resource transfer may be adjusted in related or corresponding manners. For example, during a resource transfer, a record associated with the resource transfer recipient may be adjusted to reflect an increase in value due to the transfer whereas the record associated with the entity initiating the resource transfer may be adjusted to reflect a decrease in value which is at least as large as the increase in value applied to the record associated with the resource transfer recipient.

The client device 110 may also be used for defining transfer configuration rules associated with one or more resource accounts. Specifically, a user of the client device 110 may input transfer configuration rules data in association with their resource account at the resource server 130, using the client device 110. The transfer configuration rules may be transmitted to the resource server 130 (or similar resource management system) and stored in a database accessible by the resource server 130. The transfer configuration rules are used in the disposition of resource transfer requests for resources associated with the user's account. As will be described further below, a resource management system (such as the resource server 130) may access the transfer configuration rules that associated with a resource account to determine how to process a request to transfer resources associated with the resource account.

The system of FIG. 1 also includes one or more transfer request issuing servers 150. The transfer request issuing servers 150 may be associated with entities that request resources to be transferred. More specifically, the transfer request issuing servers 150 may issue requests for resources associated with one or more resource accounts managed by the resource server 130 to be transferred to resource requesting entities (e.g. bill payees, etc.). A requesting entity may input parameters of a resource transfer request to a computing system associated with a transfer request issuing server 150, and the transfer request issuing server 150 may generate a resource transfer request for transmitting to a resource management system, such as the resource server 130. By way of example, a transfer request issuing server 150 may be associated with a merchant (or service provider, etc.), and the transfer request issuing server 150 may generate invoice data for issuing to customers. The invoice data may then be transmitted, by the transfer request issuing server 150, to the resource server 130 (or to another server associated with a clearing and/or settlement system).

The client device 110, the resource server 130, and the transfer request issuing servers 150 may be in geographically disparate locations. Put differently, the client device 110 may be remote from at least one of the resource server 130 and one or more of the transfer request issuing servers 150.

The client device 110, the resource server 130, and the transfer request issuing servers 150 are computer systems. The client device 110 may take a variety of forms including, for example, a mobile communication device such as a smartphone, a tablet computer, a wearable computer such as a head-mounted display or smartwatch, a laptop or desktop computer, or a computing device of another type.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

In the example of FIG. 1, the resource server 130 may provide both resource transfer processing (e.g. bill payment) and data holding (e.g. banking) functions. In particular, the resource server 130 may be both a financial institution server and also a bill payment processing server. The resource server 130 may, in some embodiments, be a proxy server, serving as an intermediary for requests for client devices 110 seeking resources from other servers.

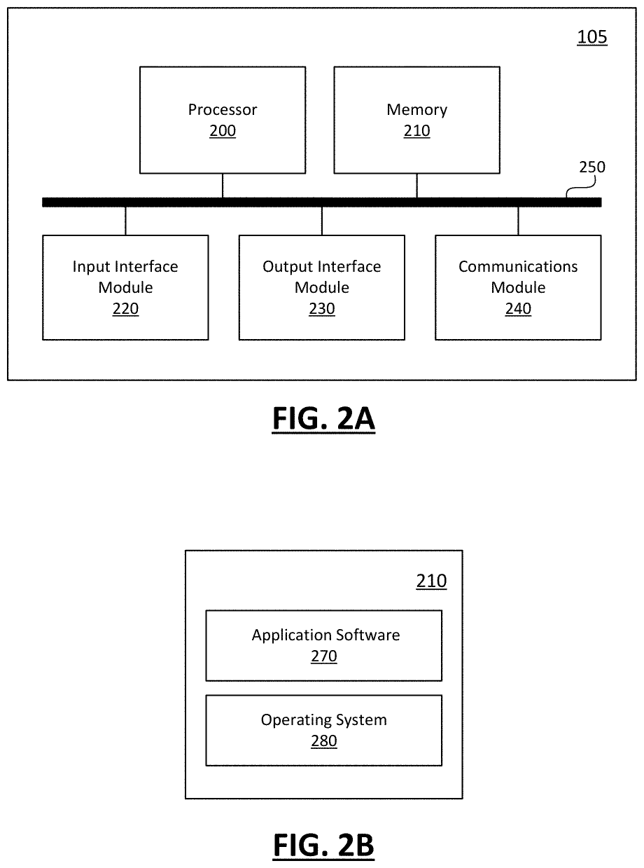

FIG. 2A is a high-level operation diagram of the example computing device 105. In at least some embodiments, the example computing device 105 may be exemplary of one or more of the client device 110, the resource server 130, and the transfer request issuing servers 150. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated these software components include application software 270 and an operating system 280.

The application software 270 adapts the example computing device 105, in combination with the operating system 280, to operate as a device performing a particular function. In some embodiments, the application software 270 may comprise a resource account management application. The resource account management application may be used, for example, to define various rules, or transfer configuration rules, for handling resource transfer requests. More particularly, a user of a client device 110 may input transfer configuration rules data in a resource account management application that is used for managing their resource account(s). For example, the user may input definitions of transfer configuration rules which specify one or more handling actions for automatically processing requests to transfer resources that are associated with the user's resource account(s). The resource transfer requests may be handled (for example, by the resource server 130) in accordance with the transfer configuration rules that are applicable for the requests

The operating system 280 is software. The operating system 280 allows the application software 270 to access the processor 200, the memory 210, the input interface module 220, the output interface module 230 and the communications module 240. The operating system 280 may be, for example, Apple iOS™, Google™ Android™, Linux™, Microsoft™ Windows™, or the like.

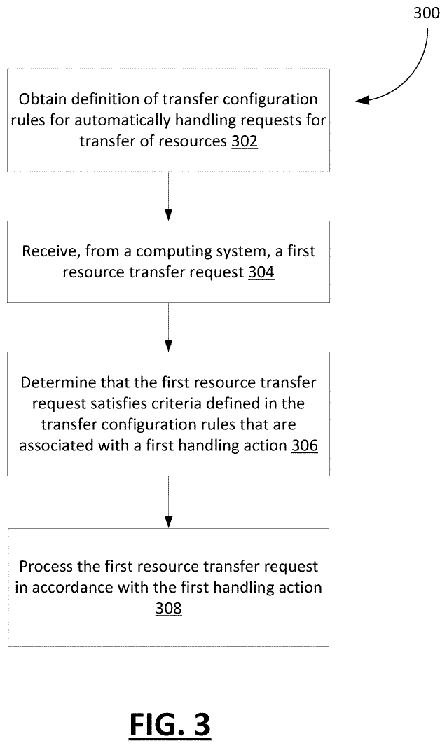

Reference is now made to FIG. 3, which shows, in flowchart form, an example method 300 for processing a resource transfer request from a request issuing server. The method 300 may be implemented by a resource management system, such as the resource server 130 of FIG. 1. More specifically, a system that manages resources associated with one or more resource accounts may implement the method 300 as part of its processing of requests to share, distribute, or otherwise transfer resources associated with the accounts.

Operations starting with operation 302 and continuing onward are performed by the processor 200 (FIG. 2A) of a computing device 200 executing software comprising instructions such as may be stored in the memory 210 of the computing device 105. For example, the operations of the method 300 may be performed by resource server 130. More particularly, processor-executable instructions may, when executed, configure a processor 200 of the resource server 130 to perform the method 300.

In operation 302, the server obtains definition of transfer configuration rules for automatically handling requests for transfer of resources. A transfer configuration rule is a rule that specifies at least one criterion that is required to be satisfied in order for a resource transfer request to be approved by the server. More specifically, a transfer configuration rule identifies at least one requirement that must be met in order for a requested resource transfer to be automatically processed and completed. Transfer configuration rules may be defined for resource accounts that are associated with a resource management system. In particular, a resource account may have one or more associated transfer configuration rules that are defined for that account. When a resource management server processes a resource transfer request, the server may identify a resource account associated with the request and access the transfer configuration rules that are defined for the account. The disposition of the resource transfer request (i.e. approval or rejection of the request) proceeds based on checking whether the resource transfer request satisfies at least a subset (or all) of the transfer configuration rules for the account that are relevant for the resource transfer request.

A transfer configuration rule defines at least one “handling action” for processing a resource transfer request. A handling action is an action which may be automatically performed by the server with respect to a resource transfer request. For example, a handling action may be transfer of a certain quantum of resources to an intended recipient of the transfer. Examples of handling actions include, among others, transferring resource(s) to one or more recipients, placing a hold on a transfer of resources, rejecting a resource transfer request, and notifying an entity associated with a resource account about a resource transfer request. In at least some embodiments, a handling action, such as transfer of resources, may be associated with a defined time period (e.g. transfer immediately, transfer on or by a certain date/time, etc.) and a quantum of resources (e.g. full requested amount, a defined minimum amount, zero, etc.).

A transfer configuration rule also defines one or more criteria associated with a handling action. More specifically, for a certain handling action (e.g. transfer resources to an intended recipient by a specific date), a transfer configuration rule may indicate one or more criteria or conditions that are required to be satisfied in order for the server to process a resource transfer request by the handling action. That is, a resource transfer request must satisfy the criteria corresponding to a handling action in order for the handling action to be automatically applied for processing the resource transfer request.

In some embodiments, a criterion may indicate one or more thresholds. For example, a transfer configuration rule may specify a maximum permissible amount of resources for which a particular handling action (e.g. transfer resources to an intended recipient) may apply. A transfer configuration rule may, for example, indicate a maximum quantum of resources that is permitted to be automatically transferred. If the server determines that a quantum of resources associated with a resource transfer request is less than the threshold, the server may process the request by automatically transferring the requested quantum of resources. A threshold may be defined on a per-request basis (i.e. threshold applies for each resource transfer request) and/or for a particular period of time (e.g. one day, one week, one month, etc.).

In some embodiments, a criterion may be associated with a transferee identifier. For example, a transfer configuration rule may specify one or more transferees for which a particular handling action is permitted (or not permitted). A transfer configuration rule may, for example, identify one or more transferees to whom resources are permitted to be automatically transferred. Additionally, or alternatively, a transfer configuration rule may identify one or more transferees to whom resources are expressly not permitted to be transferred.

In some embodiments, a criterion may be associated with a resource account balance. A resource account balance is an indicator of an amount of resources that is available to be transferred from the account. A transfer configuration rule may indicate, for each of one or more handling actions, an associated resource account balance. For example, a transfer configuration rule may specify that a resource transfer request may be automatically processed by a particular handling action if an account balance of the associated resource account exceeds a certain threshold (i.e. defined minimum account balance). A transfer configuration rule may specify a minimum threshold, a maximum threshold, and/or a range of values for a resource account balance associated with a handling action.

Other criteria which may be defined by a transfer configuration rule may relate to time period (e.g. date, time, etc.), resource transfer frequency (e.g. maximum permitted number of transfers), range of quantum of resources (e.g. upper and lower thresholds on permitted amount of resources), etc. for which a handling action may be applied for automatically processing a resource transfer request. In some embodiments, the criteria associated with a handling action may be a combination of one or more of the example criteria described above. In particular, a transfer configuration rule may specify multiple criteria/conditions which must be met before a handling action may be applied automatically in processing a resource transfer request.

A transfer configuration rule that is defined for a resource account may apply to all resource transfer requests in connection with the account. Alternatively, a transfer configuration rule may apply selectively to resource transfer requests that are associated with the resource account. For example, a transfer configuration rule may be defined such that the rule applies only to resource transfer requests originating from one or more specific requesting entities and/or transferees.

A transfer configuration rule may specify, for a particular handling action, one or more resource accounts from which transfer of resources may be initiated for processing a resource transfer request by the handling action. For example, a transfer configuration rule may specify that a resource transfer request from a particular transferee (or request issuing entity) may be handled by transferring resources from a designated resource account (e.g. chequing account). The transfer configuration rules may indicate a mapping of one or more handling actions to designated resource accounts that are permitted to be accessed for processing a resource transfer request by the handling actions. In some embodiments, the one or more resource accounts may include at least one primary account and at least one alternative account. A primary account is a default resource account from which a requested transfer associated with a resource transfer request may be made. An alternative (or back-up) account is an account which may be used to make a requested transfer of resources when the primary account is unavailable or if the resource transfer request would violate one or more of the criteria associated with the primary account (e.g. if there are insufficient amount of resources in the primary account for the requested resource transfer). More generally, the transfer configuration rules may indicate a priority order of accounts that may be used when processing resource transfer requests. The priority order may, for example, be an ordered listing of accounts. A resource transfer request may be handled by checking the transfer configuration rules associated with higher priority accounts and proceeding through the list of accounts until the resource transfer request satisfies the transfer configuration rules associated with one (if any) of the accounts.

In some embodiments, the transfer configuration rules may include a set of default handling actions for processing resource transfer requests. These “default rules” may specify one or more handling actions which may be automatically applied when there are no other defined transfer configuration rules in connection with a resource transfer request. That is, when, the default rules may trigger certain defined handling actions. For example, a default rule may indicate that the server is to (1) notify a customer (or owner, etc.) of a resource account associated with a resource transfer request that the request was received, and (2) prompt the customer to select an action to handle the request.

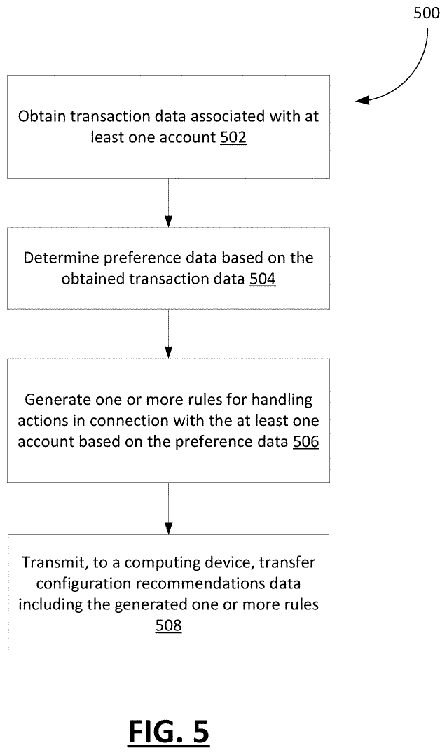

The transfer configuration rules are generated based on historical preference data of an entity associated with a resource account. More specifically, the transfer configuration rules may be automatically generated based on preference data associated with past transfer activity in connection with a resource account. The preference data may indicate, for example, transferees of one or more past resource transfers from the resource account and the parameters associated with those transfers. As will be described in greater detail below with reference to FIG. 5, the transfer configuration rules for a resource account may be generated based on historical resource transfer data, and the generated transfer configuration rules may be provided to the customer (or owner, etc.) of the resource account (for example, as rule recommendations).

In at least some embodiments, the server may receive user input of definition of one or more transfer configuration rules. In particular, the server may receive from a client device associated with an entity, such as a customer associated with a resource account, input of one or more transfer configuration rules. For example, the transfer configuration rules may be inputted via a resource management application that is resident on a customer's client device. The user input includes identifying information for the resource account, and the transfer configuration rules may apply to resource transfer requests that are associated with the identified resource account. That is, the server is configured to check whether a resource transfer request associated with a resource account satisfies criteria which are defined in the relevant transfer configuration rules for that account. If the criteria are satisfied by the resource transfer request, the server automatically processes the resource transfer request by a particular handling action.

In operation 304, the server receives, from a computing system, a first resource transfer request. The computing system may, for example, be a resource transfer request issuing server, which may be associated with one or more requesting entities (e.g. payee of a bill payment, etc.). The first resource transfer request may include metadata that includes, for example, a resource server identifier, a resource account identifier, a quantum of resources requested (e.g. full amount requested, minimum acceptable amount, etc.), type of resource requested, requesting entity identifier, intended recipient identifier, a time period (e.g. a desired date to receive the transfer), etc. The server may parse the metadata of the first resource transfer request to extract request data, including data fields and corresponding values, associated with the first resource transfer request.

In operation 306, the server determines that the first resource transfer request satisfies criteria defined in the transfer configuration rules that are associated with a first handling action. For example, the server may perform checks to determine whether the first resource transfer request meets the requirements set out by the criteria (e.g. limits on quantum of resources, time periods, recipient/transferee, etc.) associated with the first handling action. The first handling action may, for example, be transfer of requested quantum of resources to a recipient/transferee. That is, the first handling action may be a transfer action that corresponds to the requested parameters of the first resource transfer request. The server may compare the request data associated with the first resource transfer request against the transfer configuration rules for the resource account in respect of the first handling action. More specifically, the server identifies the criteria that are relevant for assessing whether the first handling action should be automatically applied for processing the first resource transfer request, and determines whether the identified criteria are satisfied by the first resource transfer request based on the request data.

In response to determining that the first resource transfer request satisfies the criteria associated with the first handling action, the server processes the first resource transfer request in accordance with the first handling action, in operation 308. For example, the server may cause the requested quantum of resources to be automatically transferred from the resource account to the recipient identified in the first resource transfer request (e.g. transferred to an account associated with the identified recipient).

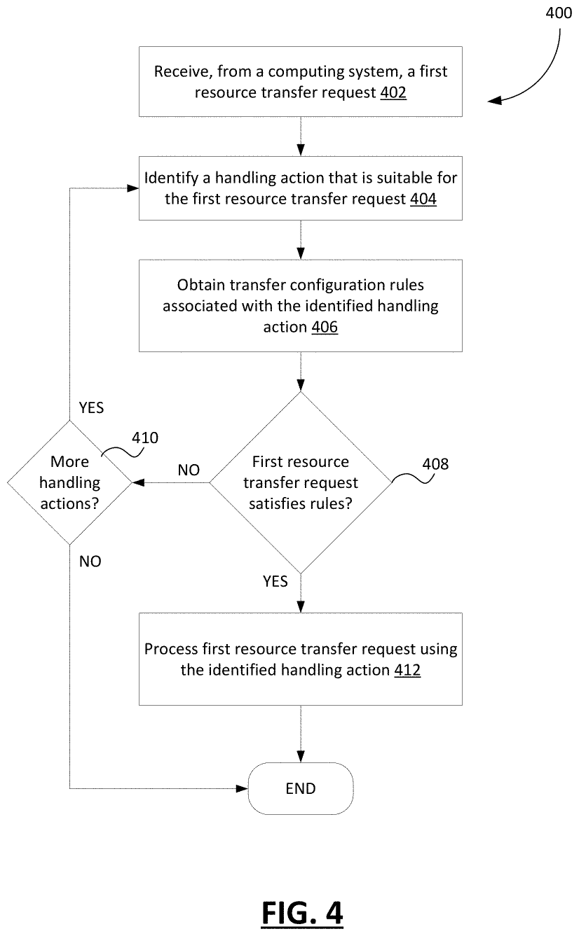

Reference is now made to FIG. 4, which shows, in flowchart form, an example method 400 for determining a suitable handling action for processing a resource transfer request. The method 400 may be implemented by a resource management system. More specifically, a system that manages resources associated with one or more resource accounts may implement the method 400 as part of its processing of requests to share, distribute, or otherwise transfer resources associated with the accounts.

Operations starting with operation 402 and continuing onward are performed by the processor 200 (FIG. 2A) of a computing device 105 executing software comprising instructions such as may be stored in the memory 210 of the computing device 105. For example, the operations of the method 400 may be performed by the resource server 130. More particularly, processor-executable instructions may, when executed, configure a processor 200 of the resource server 130 to perform the method 400. The operations of method 400 may be performed in addition to, or as alternatives, to one or more of the operations of method 300 of FIG. 3.

In operation 402, the server receives, from a computing system, a first resource transfer request. The computing system may, for example, be a resource transfer request issuing server which may be associated with one or more requesting entities. The first resource transfer request may identify, for example, a resource server, a resource account, a quantum of resources requested (e.g. full amount requested, minimum amount, etc.), type of resource requested, requesting entity, intended recipient, a time period (e.g. a desired date to receive the transfer), etc.

In operation 404, the server identifies a handling action that is suitable for the first resource transfer request. The identified handling action may be one of a plurality of handling actions which may be applicable in respect of the requested transfer associated with the first resource transfer request. For example, the identified handling action may be a transfer of resources in accordance with the parameters (e.g. requested quantum, intended recipient, etc.) of the first resource transfer request. In at least some embodiments, the server may first obtain the transfer configuration rules associated with a resource account identified in the first resource transfer request, and select one of the handling actions that are associated with the transfer configuration rules. The handling action may be selected at random from a set of handling actions associated with the identified resource account, or it may be selected based on a defined order (e.g. priority order) or ranking of handling actions. For example, the transfer configuration rules for the resource account may define a priority order of handling actions which may be automatically applied in respect to resource transfer requests. The priority order may, for example, be defined based on quantum of resources which may be transferred (e.g. higher quantum of resources corresponding to higher order/rank). When a resource transfer request in connection with the resource account is received, the server may proceed through the priority order to identify the highest ranked of the ordered handling actions which is suitable for the resource transfer request.

In operation 406, the server obtains transfer configuration rules associated with the identified handling action. In particular, the server identifies criteria defined by the transfer configuration rules for the handling action. The server then determines whether the first resource transfer request satisfies the transfer configuration rules associated with the identified handling action, in operation 408. The first resource transfer request may be determined to satisfy the transfer configuration rules if the parameters of the first resource transfer request meet all (or at least a subset) of the requirements set out by the criteria of the transfer configuration rules.

If the first resource transfer request does satisfy the transfer configuration rules associated with the identified handling action, the method 400 proceeds to operation 412 and the server processes the first resource transfer request in accordance with the handling action.

On the other hand, if the first resource transfer request does not satisfy the transfer configuration rules, the server checks to determine whether there are other handling actions which may be suitable for the first resource transfer request, in operation 410. If there is at least one alternative handling action which may be applicable for effecting a transfer of resources in connection with the first resource transfer request. By way of example, if the identified handling action is transfer of the full amount of the requested quantum of resources, an alternative handling action may be transfer of a smaller amount (e.g. a minimum acceptable amount, as indicated in the first resource transfer request) of resources to the intended recipient of the first resource transfer request.

In this way, the server iterates through one or more alternative handling actions that are suitable for the first resource transfer request and assesses whether the first resource transfer request satisfies the criteria associated with any one of the alternative handling actions. For example, the server may iterate through a priority order or ranking of handling actions and identify a highest ranked of the handling actions for which the first resource transfer request satisfies the associated criteria. Upon identifying an alternative handling action whose associated criteria are met by the parameters of the first resource transfer request, the server automatically processes the request in accordance with said alternative handling action.

In operation 410, if the server determines that there are no more defined handling actions that are suitable for the first resource transfer request, the method 400 concludes. If there are default rules that are defined for the resource account, the server may handle the first resource transfer request according to one or more of the default rules. For example, the server may prompt a customer associated with the resource account to provide selection of an action for handling the first resource transfer request. In some embodiments, the server may notify the request issuing entity that the first resource transfer request is denied. For example, if the first resource transfer request does not satisfy the criteria associated with any of the available handling actions for the resource account and the customer associated with the account does not identify a suitable handling action, the server may transmit, to the requesting entity, a message (e.g. a notification message) indicating that the first resource transfer request has been denied. Otherwise, no action is taken by the server in connection with the first resource transfer request.

Reference is now made to FIG. 5, which shows, in flowchart form, an example method 500 for generating recommendations of transfer configuration rules for resource transfers. The method 500 may be implemented by a resource management system. More specifically, a system that manages resources associated with one or more resource accounts may implement the method 500 as part of its processing of requests to share, distribute, or otherwise transfer resources associated with the accounts.

Operations starting with operation 502 and continuing onward are performed by the processor 200 (FIG. 2A) of a computing device 105 executing software comprising instructions such as may be stored in the memory 210 of the computing device 105. For example, the operations of the method 500 may be performed by the resource server 130. More particularly, processor-executable instructions may, when executed, configure a processor 200 of the resource server 130 to perform the method 500. The operations of method 500 may be performed in addition to, or as alternatives, to one or more of the operations of method 300 of FIG. 3 and method 400 of FIG. 4.

In operation 502, the server obtains transaction data associated with at least one resource account. For example, the server may retrieve, from a database storing historical transaction data for a plurality of resource accounts, transaction data for past transactions that have occurred in connection with the at least one resource account. The transaction data may include, for example, resource transfer data for past transfers from the at least one resource account. The resource transfer data may indicate, among others, identities of transferees, amount of resources transferred, and frequency of transfers.

In operation 504, the server determines transaction preference data based on the obtained transaction data. In particular, the server may identify patterns associated with parameters of past resource transfers from the at least one resource account. By way of example, the server may determine, based on the transaction data, that a transfer requesting entity issues a resource transfer request in connection a resource account at a regular frequency (e.g. once per month) and that the average quantum of resources transferred for the past transfers is less than a defined amount. The transaction preference data includes data indicating patterns of transfer parameters based on the historical transaction data. In at least some embodiments, the transaction preference data may also include user input of preference information relating to resource transfers. For example, a customer associated with the at least one resource account may indicate, via input on their client device, preference information relating to parameters for automated transfers from their account.

In operation 506, the server generates one or more rules for handling actions in connection with the at least one resource account based on the transaction preference data. In at least some embodiments, the one or more rules may indicate recommended parameters for resource transfers from the at least one resource account. For example, the rules may identify a recommended threshold as a criterion for a transfer configuration rule, based on the transaction preference data. If, for example, the transaction preference data indicates that an average quantum of resources transferred to a specific transferee is less than a certain amount, that amount can be defined as a threshold for a transfer configuration rule. If a resource transfer request is subsequently received from the transferee, the server can use the recommended threshold, defined in the transfer configuration rule, in determining whether to automatically process the resource transfer request. In a similar manner, recommended parameters such as limits on resource quantum, time periods, transferee identity, account balance, etc. may be determined based on the transaction preference data and used to define recommendations for one or more transfer configuration rules associated with the at least one resource account. The recommended parameters may be determined based on assessing, for example, frequency of a recurring transaction, variance in transaction amounts, identity of recipient associated with a transaction, etc. which are determined from the transaction data for the at least one resource account.

The server then transmits, to a computing device, the transfer configuration recommendations data including the generated one or more rules, in operation 508. For example, the transfer configuration recommendations data may be provided to a client device of a customer associated with the at least one resource account. The recommendations data may be presented, for example, via a resource management application that is resident on the client device.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computing device, comprising:
a processor;
a communications module coupled to the processor; and
a memory coupled to the processor, the memory storing instructions that, when executed, configure the processor to:
obtain definition of transfer configuration rules for automatically handling requests for transfer of resources, the transfer configuration rules defining a plurality of handling actions for processing resource transfer requests and criteria associated with the respective handling actions, wherein the transfer configuration rules are generated based on historical transaction preference data associated with an entity;
receive, from a computing system, a first resource transfer request;
determine that the first resource transfer request satisfies criteria defined in the transfer configuration rules that are associated with a first one of the plurality of handling actions; and
in response to determining that the first resource transfer request satisfies the criteria associated with the first handling action, process the first resource transfer request in accordance with the first handling action.

2. The computing device of claim 1, wherein the criteria include at least one of:
a threshold representing a maximum amount for a handling action to apply;
a transferee identifier indicating a transferee for which the handling action is to apply; or
an account balance indicating a minimum account balance for the handling action to apply.

3. The computing device of claim 1, wherein the transfer configuration rules include definition of one or more time periods corresponding to the respective handling actions.

4. The computing device of claim 1, wherein obtaining the definition of transfer configuration rules comprises receiving, from a client device, input of the definition of transfer configuration rules.

5. The computing device of claim 1, wherein the transfer configuration rules include definition of one or more accounts from which transfer of resources may be initiated for handling resource transfer requests.

6. The computing device of claim 1, wherein the transfer configuration rules include at least a primary set of rules and a secondary set of rules, the secondary set of rules including definition of at least one handling action and corresponding criteria, wherein the handling action defined by the primary set of rules is different from that defined by the secondary set of rules.

7. The computing device of claim 6, wherein determining that the first resource transfer request satisfies criteria defined in the transfer configuration rules that are associated with the first one of the plurality of handling actions comprises:
determining that the first resource transfer request does not satisfy criteria associated with any of the handling actions defined in the primary set of rules; and
in response to determining that the first resource transfer request does not satisfy criteria associated with any of the handling actions defined in the primary set of rules, checking criteria associated with the at least one handling action defined in the secondary set of rules.

8. The computing device of claim 1, wherein the transfer configuration rules include definition of quantum of resources for transfer associated with the respective handling actions.

9. The computing device of claim 1, wherein the transfer configuration rules include a set of default handling actions for processing resource transfer requests.

10. The computing device of claim 1, wherein the instructions, when executed, configure the processor to:
generate recommendations of one or more transfer configuration rules based on the historical transaction preference data; and
provide, to a client device, the generated recommendations.

11. A processor-implemented method, comprising:
obtaining definition of transfer configuration rules for automatically handling requests for transfer of resources, the transfer configuration rules defining a plurality of handling actions for processing resource transfer requests and criteria associated with the respective handling actions, wherein the transfer configuration rules are generated based on historical transaction preference data associated with an entity;
receiving, from a computing system, a first resource transfer request;
determining that the first resource transfer request satisfies criteria defined in the transfer configuration rules that are associated with a first one of the plurality of handling actions; and
in response to determining that the first resource transfer request satisfies the criteria associated with the first handling action, processing the first resource transfer request in accordance with the first handling action.

12. The method of claim 11, wherein the criteria include at least one of:
a threshold representing a maximum amount for a handling action to apply;
a transferee identifier indicating a transferee for which the handling action is to apply; or
an account balance indicating a minimum account balance for the handling action to apply.

13. The method of claim 11, wherein the transfer configuration rules include definition of one or more time periods corresponding to the respective handling actions.

14. The method of claim 11, wherein obtaining the definition of transfer configuration rules comprises receiving, from a client device, input of the definition of transfer configuration rules.

15. The method of claim 11, wherein the transfer configuration rules include definition of one or more accounts from which transfer of resources may be initiated for handling resource transfer requests.

16. The method of claim 11, wherein the transfer configuration rules include at least a primary set of rules and a secondary set of rules, the secondary set of rules including definition of at least one handling action and corresponding criteria, wherein the handling action defined by the primary set of rules is different from that defined by the secondary set of rules.

17. The method of claim 16, wherein determining that the first resource transfer request satisfies criteria defined in the transfer configuration rules that are associated with the first one of the plurality of handling actions comprises:
determining that the first resource transfer request does not satisfy criteria associated with any of the handling actions defined in the primary set of rules; and
in response to determining that the first resource transfer request does not satisfy criteria associated with any of the handling actions defined in the primary set of rules, checking criteria associated with the at least one handling action defined in the secondary set of rules.

18. The method of claim 11, wherein the transfer configuration rules include definition of quantum of resources for transfer associated with the respective handling actions.

19. The method of claim 11, wherein the transfer configuration rules include a set of default handling actions for processing resource transfer requests.

20. The method of claim 11, further comprising:
generating recommendations of one or more transfer configuration rules based on the historical transaction preference data; and
providing, to a client device, the generated recommendations.
